(19) United States
(12) Patent Application Publication
(10) Pub. No.: US 2019/0191326 A1
(43) Pub. Date: Jun. 20, 2019

(54) RELAY COMMUNICATION APPARATUS, METHOD, AND NON-TRANSITORY COMPUTER-READABLE STORAGE MEDIUM FOR STORING PROGRAM FOR RELAY COMMUNICATION

(71) Applicant: FUJITSU LIMITED, Kawasaki-shi (JP)

(72) Inventors: Yoshiko Tsuji, Fukuoka (JP); Shinya Yamamura, Fukuoka (JP)

(73) Assignee: FUJITSU LIMITED, Kawasaki-shi (JP)

(21) Appl. No.: 16/209,223

(22) Filed: Dec. 4, 2018

(30) Foreign Application Priority Data
Dec. 20, 2017 (JP) 2017-243660

(51) Int. Cl. H04W 24/10; H04W 88/04; H04W 8/22; H04L 29/12; H04L 12/26

(52) U.S. Cl. CPC H04W 24/10; H04W 88/04; H04L 43/16; H04L 61/6013; H04W 8/22

(57) ABSTRACT

A relay communication apparatus includes: a buffer configured to store data to be relayed from a first apparatus to a second apparatus in a case where the data is to be relayed from the first apparatus to the second apparatus and when a communication link with the second apparatus is not established; and a transfer control circuitry configured to control transfer processing on the data based on at least one control rule according to a purpose of the data before the data is transferred to the second apparatus and according to a disruption tolerant protocol when a communication link with the second apparatus is established.

### CROSS-REFERENCE TO RELATED APPLICATION

This application is based upon and claims the benefit of priority of the prior Japanese Patent Application No. 2017-243660, filed on Dec. 20, 2017, the entire contents of which are incorporated herein by reference.

### FIELD

The present disclosure relates to a relay communication apparatus, a relay communication method, and a non-transitory computer-readable storage medium for storing a program for relay communication.

### BACKGROUND

In recent years, the wide spread of a plurality of wireless communication measures results in spread of a manner by which a terminal apparatus such as a smartphone performs communication by changing the wireless LAN (Local Area Network) access point such as Wi-Fi and the broadband wireless connection of a communication carrier. In such an environment, because its communication state is influenced by the number of connected terminals and a state of ambient electric waves, the quality of communication may vary in accordance with the location and time, which may possibly result in intermittent communications.

For example, in a case where, a terminal apparatus while moving communicates with a server over the Internet by changing the wireless communication unit to be linked, a higher amount of data is communicated. Moreover, when the terminal apparatus stays for a short period of time within a linkable range of the wireless communication unit, the corresponding communication is disconnected incompletely. Therefore, the communication may be to be restarted after re-linking with another wireless communication unit. Even when the terminal apparatus stays still, the communication may be intermittent because of an influence such as electric wave interferences with other wireless communication units. Even over a wired network, the communication may be intermittent with a certain number of connections of the terminal or due to some states of the wired network.

In order to overcome such problems, providing an application in a terminal with tolerance against communication delays or disruption has been under review. For example, as a technology enabling smooth communication even in an environment with intermittent communication, delay, disruption tolerant networking (DTN) has been known. This technology has been standardized by The Internet Engineering Task Force (IETF). For example, Request For Comments (RFC) 5050 provides a bundle protocol (which may be called a disruption tolerance protocol) for application to a DTN.

Examples of the related art include Japanese Laid-open Patent Publication No. 2008-205890, International Publication Pamphlet No. WO2009/078427, Japanese Laid-open Patent Publication No. 2000-278313, RFC4838, Delay-Tolerant Networking Architecture, (April 2007), https://tools.ietf.org/html/rfc 4838, and RFC5050, Bundle Protocol Specification, (November 2007), https://tools.ietf.org/html/rfc 5050.

### SUMMARY

According to an aspect of the embodiments, a relay communication apparatus includes: a buffer configured to store data to be relayed from a first apparatus to a second apparatus in a case where the data is to be relayed from the first apparatus to the second apparatus and when a communication link with the second apparatus is not established; and a transfer control circuitry configured to control transfer processing on the data based on at least one control rule according to a purpose of the data before the data is transferred to the second apparatus and according to a disruption tolerant protocol when a communication link with the second apparatus is established.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a flow of a signal between nodes in an example of a system configuration according to Embodiment 1;

FIG. 2 illustrates an example of address conversion information;

FIG. 3 illustrates an example of destination information;

FIG. 4 illustrates an example of application information;

FIG. 5 illustrates an example of control rule information;

FIG. 6 illustrates examples of a control method and a control rule group;

FIG. 7 illustrates an example of DTN path information;

FIG. 8 illustrates an example of DTN setting information;

FIG. 9 illustrates an example of node setting information;

FIG. 10 illustrates an example of a flow of transmission processing at a DTN node according to Embodiment 1;

FIG. 11 illustrates an example of a configuration of a terminal apparatus according to Embodiment 2;

FIG. 12 illustrates an example of a connection list; and

FIG. 13 illustrates examples of hardware configurations of a terminal apparatus and a server apparatus 20 in a system.

### DESCRIPTION OF EMBODIMENTS

DTN and bundle protocols are originally assumed to be applied to communication not having a real time characteristic (which may be also called immediacy) such as communication under a special environment such as in the space or under the sea and assuming delays. Therefore, it is difficult for DTN and bundle protocols to be directly used for general applications. In order to implement DTN and bundle protocols to communication by a general application, a proxy function (which may be called a DTN proxy) may be used which performs communication based on DTN or a bundle protocol.

A DTN proxy may put data to be transmitted to the other communication partner by an application into a bundle, and store the bundle in a buffer while the communication is being disconnected, and the data are transmitted after recovery of the communication. Through the DTN proxy in the communication with the other communication partner, the application may receive the benefits of the relay communication based on DTN.

The DTN proxy starts transmission of data retained in the buffer when the recovery of the communication is detected. In this case, because the time for disconnection of the communication is not fixed, the buffer retention times of data may vary significantly between data pieces.

In some applications of data, the freshness of the data may become obsolete while being retained in the buffer, and therefore the data buffered in a relatively longer retention time is no longer proper. For example, in a case of a service with high immediacy such as a service for detecting an abnormality from video image data captured by a monitoring camera, relatively old video image data may not be concerned.

However, disadvantageously, data retained in a buffer in the DTN proxy is data which has been already transmitted by the application, the application may not control the data.

The data transmitted from an application may be used for various purposes. The data may be concerned with some purposes while it may not be concerned with other purposes. For example, video image data captured by a monitoring camera may be used for a service with immediacy which, for example, detects an abnormality from the video image data and as well as for a service without immediacy which analyzes a flow of people from the video image data to analyze and enhance works.

Therefore, it may not be proper to transfer relatively new data pieces of data retained in a buffer in a DTN proxy and to abandon the other old data pieces.

According to an aspect of the present disclosure, it is an object to provide a technology which, even after data is transmitted from an application, may control relay communication of the data transmitted from the application in accordance with the purpose of the data transmitted from the application.

With reference to drawings, embodiments of a control technology relating to relay communication according to the present disclosure will be described in detail below. It is not intended that the following embodiments limit the disclosed technology. Apparently, the following embodiments may be implemented in combination. All of contents of RFC4838, Delay-Tolerant Networking Architecture, (April 2007), https://tools.ietf.org/html/rfc 4838 and RFC5050, Bundle Protocol Specification, (November 2007), https://tools.ietf.org/html/rfc 5050] are incorporated for reference.

### Embodiment 1

In a system according to Embodiment 1, a control rule is defined in accordance with the purpose of data to be transmitted from an upper layer application in a DTN (DTN: Delay, Disruption Tolerant Networking) proxy which relays communication between applications (which may be called “between nodes”). Thus, the DTN proxy is capable of controlling the relay communication in accordance with the purpose of the data to be transmitted from the application.

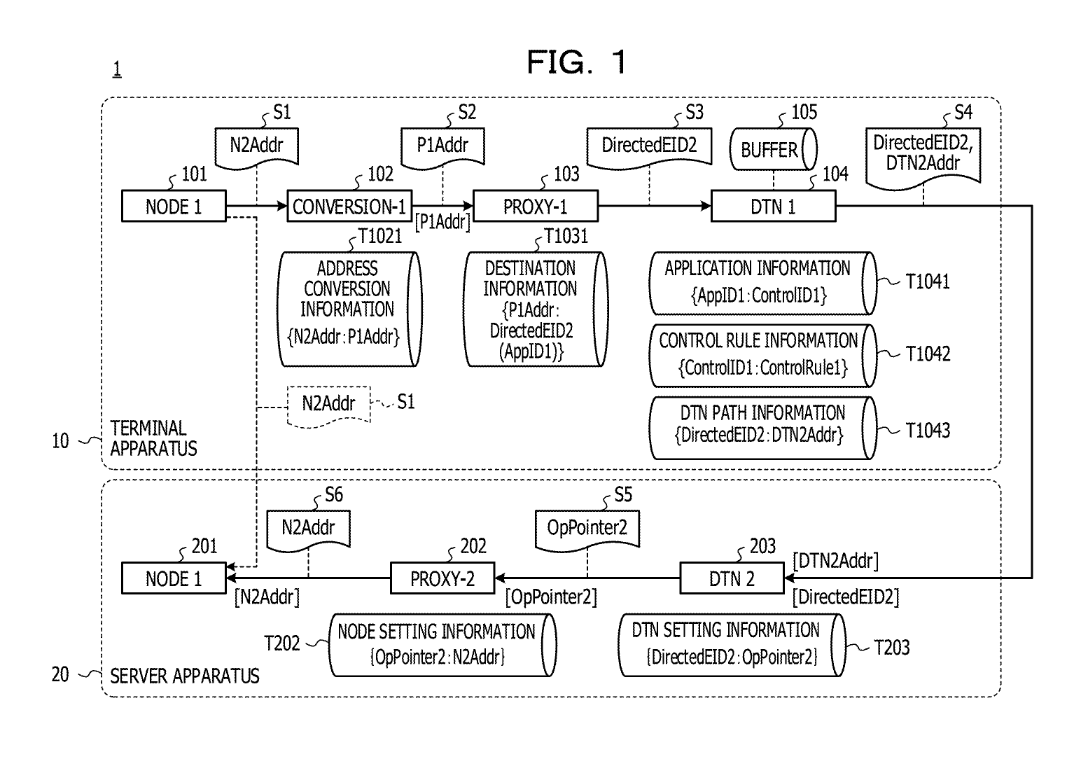

FIG. 1 illustrates an example of a flow of a signal between nodes in an example of a system configuration according to Embodiment 1. A system 1 illustrated in FIG. 1 includes a terminal apparatus 10 and a server apparatus 20. The terminal apparatus 10 and the server apparatus 20 are communicably coupled over a network. However, the terminal apparatus 10 and the server apparatus 20 may not keep the communicable state.

The terminal apparatus 10 has a node 1 (101) (which may also be called a first node), a conversion-1 processing unit 102 (which may also be called a first conversion processing unit), a proxy-1 processing unit 103 (which may also be called a first proxy processing unit), a DTN-1 processing unit 104 (which may also be called a first DTN processing unit), a buffer 105, address conversion information T1021, destination information T1031, application information T1041, control rule information T1042, and DTN path information T1043. The node 1 (101) is an example of an application (which may also be called a client application or a client) running on the terminal apparatus 10 and is a first device according to one aspect.

The server apparatus 20 has a node 2 (201) (which may also be called a second node), a proxy-2 processing unit 202 (which may also be called a second proxy processing unit), a DTN-2 processing unit 203 (which may also be called a second DTN processing unit), node setting information T202, and DTN setting information T203. The node 2 (201) is an example of an application (which may also be called a server application or a server) running on the server apparatus 20 and is a second device according to the aspect.

The DTN-1 processing unit 104 in the terminal apparatus 10 is configured to relay a signal from the node 1 (101) in the terminal apparatus 10 to the node 2 (201) in the server apparatus 20 based on a DTN (or Delay, Disruption Tolerant Networking) protocol (which may also be called a disruption-tolerant protocol). In other words, for example, the DTN-1 processing unit 104 according to an aspect is an example of a transfer control unit in a relay communication apparatus which relays communication between the node 1 (101) in the terminal apparatus 10 and the node 2 (201) in the server apparatus 20. The relay communication apparatus may include the DTN-1 processing unit 104 and the proxy-1 processing unit 103. Referring to FIG. 1, the DTN-1 processing unit 104 and the proxy-1 processing unit 103 are illustrated as being implemented within the terminal apparatus 10. However, the present disclosure is not necessarily limited thereto. The DTN-1 processing unit 104 and the proxy-1 processing unit 103 may be implemented in housing (which may also be called a relay communication apparatus) different from the terminal apparatus 10. In other words, for example, in the illustration in FIG. 1, the relay communication apparatus may be implemented within the terminal apparatus 10 according to an aspect.

The DTN-2 processing unit 203 in the server apparatus 20 is an example of the relay communication apparatus which relays communication between the terminal apparatus 10 and the server apparatus 20 based on a DTN protocol and is configured to receive a signal to be relayed from the DTN-1 processing unit 104 in the terminal apparatus 10 and transfer it to the node 2 (201) in the server apparatus 20 through the proxy-2 processing unit 202.

A flow of data from the node 1 (101) to the node 2 (201) will be described in the system configuration illustrated in FIG. 1. First, in order to transmit data from the node 1 (101) to the node 2 (201), the terminal apparatus 10 designates an address N2Addr of the node 2 and transmits a signal S1 including the data from the node 1 (101).

The signal S1 transmitted from the node 1 (101) in the terminal apparatus 10 may be received by the server apparatus 20 at the address N2Addr of the node 2 (201) over the network. Thus, the data included in the signal S1 transmitted from the node 1 (101) is received by the node 2 (201) running on the server apparatus 20 over the network. In this case, the processing in the conversion-1 processing unit 102, the proxy-1 processing unit 103, the DTN-1 processing unit 104, the DTN-2 processing unit 203, and the proxy-2 processing unit 202 illustrated in FIG. 1 may be omitted. The address N2Addr of the node 2 (201) may include an Internet Protocol (IP) address or a combination of an IP address and a port number, for example.

The terminal apparatus 10 may transfer the signal S1 transmitted from the node 1 (101) to the proxy-1 processing unit 103 through the conversion-1 processing unit 102 (which may be indicated by a signal S2). The terminal apparatus 10 may convert in the conversion-1 processing unit 102 the address N2Addr indicated in the signal S1 to an address P1Addr of the proxy-1 processing unit 103 based on the address conversion information T1021.

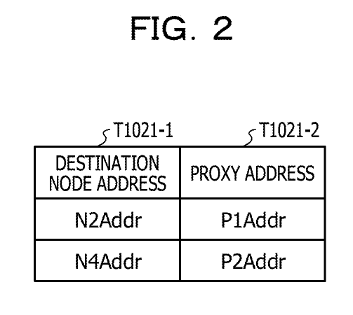

FIG. 2 illustrates an example of address conversion information T1021. The address conversion information T1021 illustrated in FIG. 2 includes a destination node address T1021-1 and a proxy address T1021-2. The destination node address T1021-1 is an address before the conversion and indicates an address of a destination node of a communication to be relayed. The proxy address T1021-2 is an address after the conversion and indicates an address of the proxy-1 processing unit 103. In the example in FIG. 2, a destination node address T1021-1 “N2Addr” and a proxy address T1021-2 “P1Addr” are associated, and a destination node address T1021-1 “N4Addr” and a proxy address T1021-2 “P2Addr” are associated. The destination node address T1021-1 “N2Addr” is an example of an address of the node 2 (201), a destination node, in the server apparatus 20. The proxy address T1021-2 “P1Addr” is an example of an address of the proxy-1 processing unit 103 configured to receive data from the node 1 (101) through the conversion-1 processing unit 102 (which may also be called an address conversion unit 102). The destination node address T1021-1 “N4Addr” is an example of an address of a node of the server apparatus 20 (not illustrated in FIG. 1), and the proxy address T1021-2 “P2Addr” is an example of an address of the proxy-1 processing unit 103 that is a node in the terminal apparatus 10 and that is configured to receive data from a node that is different from the node 1 (101). For example, “P1Addr” and “P2Addr” may be distinguished based on respective port numbers. The proxy address T1021-2 and the destination node address T1021-1 have a one-to-one relationship. In other words, for example, the proxy address T1021-2 is associated with the destination node address T1021-1. For convenience of descriptions, simplified values are used for setting items, but it is to be noted that the values may not be identical to values that are actually to be used.

The conversion-1 processing unit 102 may change the connection destination of a socket set up (generated) with the address N2Addr designated by the node 1 (101) to the proxy-1 processing unit 103 indicated by the address P1Addr based on the address conversion information T1021. In other words, for example, the signal S1 transmitted from the node 1 (101) is converted to a signal S2 to be transferred to the proxy-1 processing unit 103 indicated by the address P1Addr through the conversion-1 processing unit 102.

The proxy-1 processing unit 103 having received the signal S2 transfers a signal S3 including a destination EID (Directed EID (Endpoint IDentification)) 2 indicated in the destination information T1031 and data included in the signal S2 to the DTN-1 processing unit 104. In order to receive the signal S2 including the data transmitted from the node 1 (101), the proxy-1 processing unit 103 may generate in advance a socket (which may also be called a server socket) with the address P1Addr designated based on the destination information T1031 (which may also be called an initial setting). As indicated by the address conversion information T1021 in FIG. 2, the address P1Addr of the proxy-1 processing unit 103 and the address N2Addr of the node 2 (201) have a one-to-one relationship. In other words, for example, the socket of the address P1Addr is associated with the node 2 (201).

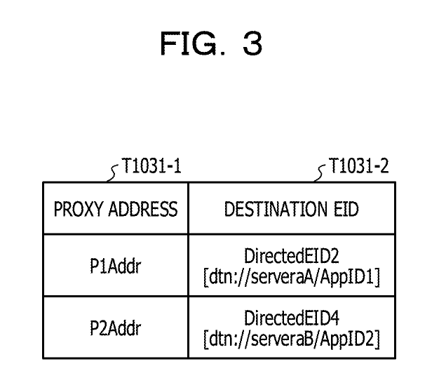

FIG. 3 illustrates an example of the destination information T1031. The destination information T1031 illustrated in FIG. 3 includes a proxy address T1031-1 and a destination EID (T1031-2). The proxy address T1031-1 indicates an address of the proxy-1 processing unit 103. The destination EID (T1031-2) indicates an address of a DTN processing unit corresponding to a destination node. According to the example in FIG. 3, the proxy address T1031-1 “P1Addr” and the destination EID (T1031-2) “DirectedEID2” are associated, and the proxy address T1031-1 “P2Addr” and the destination EID (T1031-2) “DirectedEID4” are associated. In the example in FIG. 3, the proxy address T1031-1 “P1Addr” and the destination EID (T1031-2) “DirectedEID2” have a one-to-one relationship. For convenience of descriptions, simplified values are used for setting items, but it is to be noted that the values may not be identical to values that are actually to be used.

The destination EID (Directed Endpoint IDentification) is information acting as identification information of a node according to a DTN (Delay, Disruption Tolerant Networking) protocol. In the example in FIG. 1, nodes according to a DTN protocol (which may also be called a DTN node) may be the DTN-1 processing unit 104 and the DTN-2 processing unit 203. The destination EID2 (DirectedEID2) indicated by the signal S3 in the example in FIG. 1 is identification information indicating the DTN-2 processing unit 203 running on the server apparatus 20. In the example in FIG. 3, “dtn://serverA/AppID1” is illustrated as an example of the destination EID (T1031-2) “DirectedEID2”, and “dtn://serverB/AppID2” is illustrated as an example of a destination EID (T1031-2) “DirectedEID4”.

The destination EID (which may also be called a destination EID2 indicated by the signal S3 has an information structure such as “dtn://<destination node name >/<application ID>”. The part “dtn://” in the destination EID is an example of a protocol indication to be used when the DTN protocol is used. The part “<destination node name>” of the destination EID indicates identification information indicating a DTN node running on the server apparatus 20 that is a substantial destination of the data to be transmitted from the node 1 (101). A destination EID2 is identification information indicating the DTN-2 processing unit 203 running on the server apparatus 20. A part “<application ID>” of the destination EID indicates identification information based on the purpose (which may also be called an application) of data to be transmitted from the node 1 (101) (which may also be called application identification information or an application ID or an App ID). The aforementioned information structure of the destination EID given for illustration purpose, and the present disclosure is not limited thereto. For example, another information element may be inserted between “<destination node name>” and “<application ID>”.

When the signal S3 is received, the DTN-1 processing unit 104 (which may also be called a transfer control unit) obtains an application ID (which may also be called an application ID of the signal S3 or App ID of the signal S3) based on the destination EID2 included in the signal S3 and executes processing defined under a control rule corresponding to the application ID of the signal S3. Thus, the relay communication may be controlled in accordance with the purpose (which may also be called an application) of the data to be transmitted from the node 1 (101).

For example, in the DTN-1 processing unit 104, the terminal apparatus 10 may obtain a control ID (which may also be called a control ID of the signal S3) corresponding to the application ID of the signal S3 from the application information T1041.

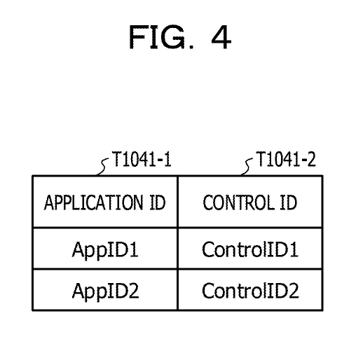

FIG. 4 illustrates an example of the application information T1041. The application information T1041 illustrated in FIG. 4 includes an application ID (T1041-1) and a control ID (T1041-2). The application ID (T1041-1) is identification information indicating a purpose of data to be transmitted from the node 1 (101). The control ID (T1041-2) is identification information indicating a control rule corresponding to the purpose of data to be transmitted from the node 1 (101). In the example in FIG. 4, the application ID (T1041-1) “AppID1” and the control ID (T1041-2) “control ID1” are associated, and the application ID (T1041-1) “AppID2” and the control ID (T1041-2) “control ID2” are associated.

In the DTN-1 processing unit 104, the terminal apparatus 10 may obtain from the control rule information T1042 a control rule (which may also be called a control rule of the signal S3) corresponding to the control ID of the signal S3.

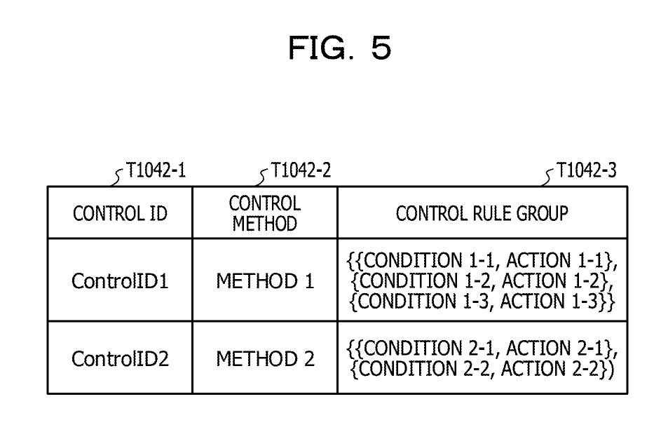

FIG. 5 illustrates an example of the control rule information T1042. The control rule information T1042 illustrated in FIG. 5 includes a control ID (T1042-1), the control method T1042-2 and a control rule group T1042-3. The control ID (T1042-1) is identification information uniquely indicating the control rule information T1042. The control method T1042-2 is information indicating which control method of a plurality of control method that is prepared in advance is to be used. In other words, for example, the control method T1042-2 according to an aspect designates a value to be measured as a value to be applied for judgment of a condition predefined in the control rule group T1042-3. The control rule group T1042-3 includes a combination of a condition to be judged regarding its satisfaction according to the control method indicated in the control method T1042-2 and an action to be executed when the condition is satisfied.

In the example in FIG. 5, the control rule information T1042 having a control ID (T1042-1) “control ID1” and a control method T1042-2 “system 1” has three combinations of conditions and actions, which are set as the control rule group T1042-3. In the example in FIG. 5, when a condition 1-1 is satisfied in the control method indicated by the control method T1042-2 “system 1”, an action 1-1 is executed. When a condition 1-2 is satisfied, an action 1-2 is executed. When a condition 1-3 is satisfied, the action 1-3 is executed.

According to another example in FIG. 5, a control rule information T1042 having a control ID (T1042-1) “control ID2” and the control method T1042-2 “method 2” have two combinations of conditions and actions, which are set as the control rule group T1042-3. In other words, for example, according to the other example in FIG. 5, when a condition 2-1 is satisfied in the control method indicated by the control method T1042-2 “method 2”, an action 2-1 is executed. When a condition 2-2 is satisfied, an action 2-2 is executed.

The control method T1042-2 may be a control method including selecting and executing an applicable action from the control rule group T1042-3 based on an elapsed time from a time when data from the node 1 (101) is transferred to the DTN-1 processing unit 104. In this case, conditions in combinations set in the control rule group T1042-3 may include whether the elapsed time is equal to or higher than a predetermined value, whether the elapsed time is equal to or lower than the predetermined value, whether the elapsed time is equal to the predetermined value, whether the elapsed time is higher than the predetermined value, and whether the elapsed time is lower than the predetermined value. Alternatively, as an example of the control method T1042-2, a control method may be applied which includes selecting and executing an applicable action from the control rule group T1042-3 based on the size of data from the node 1 (101). In this case, the conditions in the combinations set in the control rule group T1042-3 may include whether the data size is equal to or higher than a predetermined value, whether the data size is equal to or lower than the predetermined value, whether the data size is equal to the predetermined value, whether the data size is higher than the predetermined value, whether the data size is lower than the predetermined value and so on.

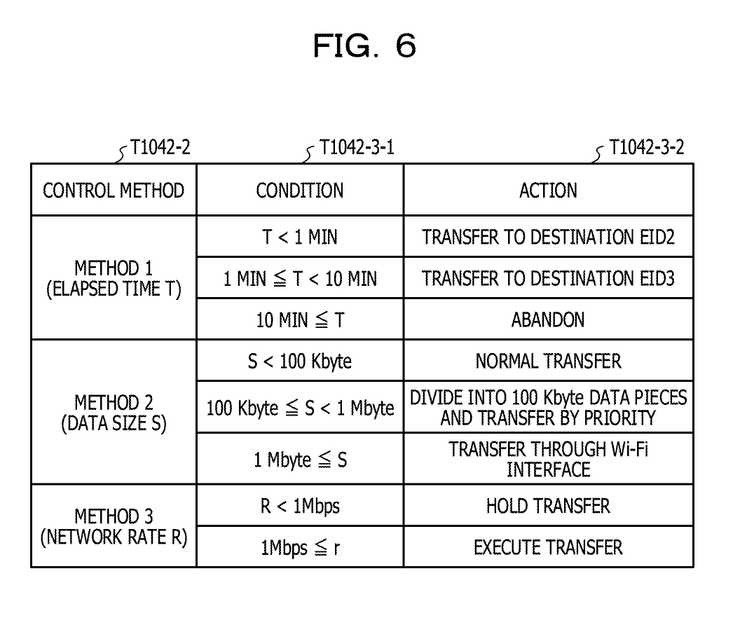

FIG. 6 illustrates examples of a control method and a control rule group. In an example in FIG. 6, a control rule group T1042-3 including one or more combinations of a condition T1042-3-1 and an action T1042-3-2 is set for the control method T1042-2.

Referring to FIG. 6, for example, a control rule based on a combination of a condition T1042-3-1 “T<1 MIN” and an action T1042-3-2 “TRANSFER TO DESTINATION EID2” is associated with the control method T1042-2 based on a “METHOD 1 (ELAPSED TIME T)” indicating a control based on an elapsed time T. This means that the elapsed time T is measured based on the control method T1042-2 “METHOD 1 (ELAPSED TIME T)”. When the measurement result (elapsed time T) is lower than one minute, a control is executed which transfers data from the node 1 (101) to a destination EID2. In this case, the elapsed time T may be an elapsed time from a time when data is transferred from the node 1 (101) to the DTN-1 processing unit 104 or an elapsed time from a time when a signal S1 including the data is generated at the node 1 (101) (which may also be called an elapsed time from a data generation).

Referring to FIG. 6, for example, a control rule based on a combination of a condition T1042-3-1 “1 MIN T<10 MIN” and an action T1042-3-2 “TRANSFER TO DESTINATION EID3” is associated with the control method T1042-2 “METHOD 1 (ELAPSED TIME T)”. This means that an elapsed time T is measured based on the control method T1042-2 “METHOD 1 (ELAPSED TIME T)”. When the measurement result (elapsed time T) is equal to or higher than one minute and lower than ten minute, a control is performed which transfers data from the node 1 (101) to a destination EID3. In other words, for example, the control rule according to one aspect changes the transfer destination from the node 1 (101) of data to the destination EID3 when the measured elapsed time T is equal to or higher than a first threshold value (1 minute) based on the control method T1042-2 “METHOD 1 (ELAPSED TIME T)”.

Referring to FIG. 6, for example, a control rule based on a combination of a condition T1042-3-1 “10 MIN T” and an action T1042-3-2 “ABANDON” is associated with the control method T1042-2 “METHOD 1 (ELAPSED TIME T)”. This means that the elapsed time T is measured based on the control method T1042-2 “METHOD 1 (ELAPSED TIME T)”. When the measurement result (elapsed time T) is equal to or higher than 10 minutes, a control is performed which abandon the data from the node 1 (101). In other words, for example, the control rule according to another aspect abandons the data from the node 1 (101) when the elapsed time T measured based on the control method T1042-2 “METHOD 1 (ELAPSED TIME T)” satisfies a condition that it is equal to or higher than a second threshold value (10 minutes) that is higher than the first threshold value.

Referring to FIG. 6, for example, a control rule based on a combination of a condition T1042-3-1 “S<100 Kbyte” and an action T1042-3-2 “NORMAL TRANSFER” is associated with the control method T1042-2 for a “METHOD 2 (DATA SIZE S)” indicating a control based on a data size S. This means that a data size S of data from the node 1 (101) is measured based on the control method T1042-2 “METHOD 2 (DATA SIZE S)”. A control is performed which normally transfers the data from the node 1 (101) to a designated destination when the measurement result (the data size S of the data from the node 1 (101)) is lower than 100 Kbyte.

Referring to FIG. 6, for example, a control rule based on a combination of a condition T1042-3-1 “100 Kbyte S<1 Mbyte” and an action T1042-3-2 “DIVIDE INTO 100 Kbyte DATA PIECES AND TRANSFER BY PRIORITY” is associated with the control method T1042-2 “METHOD 2 (DATA SIZE 5)”. This means that the data size S of data from the node 1 (101) is measured based on the control method T1042-2 “METHOD 2 (DATA SIZE 5)”. When the data size S of the data in the measurement result (node 1 (101) is equal to or higher than 100 Kbyte and lower than 1 Mbyte, a control is performed which divides the data from the node 1 (101) into 100 Kbyte data pieces and transfers the data pieces to a designated destination by priority.

Referring to FIG. 6, for example, a control rule based on a combination of a condition T1042-3-1 “1 Mbyte 5” and an action T1042-3-2 “TRANSFER VIA WI-FI INTERFACE” is associated with the control method T1042-2 “METHOD 2 (DATA SIZE 5)”. This means that the data size S of data from the node 1 (101) is measured based on the control method T1042-2 “METHOD 2 (DATA SIZE 5)”. When the measurement result (the data size S of the data from node 1 (101)) is equal to or higher than 1 Mbyte, a control is performed which transfers the data from the node 1 (101) via a Wi-Fi interface when the Wi-Fi interface is enabled.

Referring to FIG. 6, for example, a control rule based on a combination of a condition T1042-3-1 “R<1 Mbps” and an action T1042-3-2 “HOLD TRANSFER” is associated with a control method T1042-2 based on a “METHOD 3 (NETWORK RATE R)” indicating a control based on the network rate R. This means that a communication rate R (which may also be called a network rate R) of a network to be used for transferring data from the node 1 (101) is measured based on the control method T1042-2 “METHOD 3 (NETWORK RATE R)”. When the measurement result (network rate R) is lower than 1 Mbps, a control is performed which holds transfer of data from the node 1 (101).

Referring to FIG. 6, for example, a control rule based on a combination of a condition T1042-3-1 “1 Mbps R” and an action T1042-3-2 “EXECUTE TRANSFER” is associated with the control method T1042-2 “METHOD 3 (NETWORK RATE R)”. This means that a communication rate R (which may also be called a network rate R) of a network to be used for transferring data from the node 1 (101) is measured based on the control method T1042-2 “METHOD 3 (NETWORK RATE R)”. When the measurement result (network rate R) is equal to or higher than 1 Mbps, a control is performed which transfers data from the node 1 (101) to a designated destination.

Next, the DTN-1 processing unit 104 obtains a destination address corresponding to the destination EID based on the DTN path information T1043. The destination EID may be a destination EID indicated by the signal S3 or may be a destination EID designated by a control according to the purpose of the data.

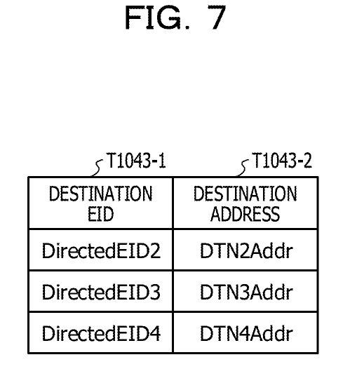

FIG. 7 illustrates examples of the DTN path information T1043. The DTN path information T1043 illustrated in FIG. 7 includes a destination EID (T1043-1) and a destination address T1043-2. The destination EID (T1043-1) indicates an address (which may also be called a DTN address) of a DTN processing unit corresponding to a destination node. The destination address T1043-2 indicates an address over a network of an apparatus on which the DTN processing unit (which may also be called a transfer destination DTN node) corresponding to the destination node runs and may include an IP address and a port number, for example. In the example in FIG. 7, the destination EID (T1043-1) “DirectedEID2” of the DTN-2 processing unit 203 corresponding to the node 2 (201) and the destination address T1043-2 “DTN2Addr” are associated. In the example in FIG. 7, a destination EID (T1043-1) “DirectedEID3” of the DTN processing unit (not illustrated in FIG. 1) corresponding to a node 3 and a destination address T1043-2 “DTN3Addr” are associated. In the example in FIG. 7, a destination EID (T1043-1) “DirectedEID4” of the DTN processing unit (not illustrated in FIG. 1) corresponding to a node 4 and a destination address T1043-2 “DTN4Addr” are associated. For convenience of descriptions, simplified values are used for setting items, but it is to be noted that the values may not be identical to values that are actually to be used.

The DTN-1 processing unit 104 may judge whether communication with the communication partner at the destination address over a network is enabled or not, and, when so, may transmit a signal S4 including the data from the node 1 (101) to the communication partner identified with the destination address based on the DTN protocol. Thus, the DTN processing unit 104 may perform the control according to the purpose of the data on the data from the node 1 (101) and may then transmit the signal S4 including the data from the node 1 (101) based on the DTN protocol to the communication partner at the destination address corresponding to the destination EID. The signal S4 may include the destination EID indicated in the signal S3 or may include the destination EID designated by the control according to the purpose of the data. In other words, for example, in a case where the signal S4 is to be transmitted to the other communication partner at the destination address corresponding to the destination EID indicated in the destination information T1031, the signal S4 may include the destination EID indicated in the destination information T1031. Alternatively, in a case where the signal S4 is to be transmitted to the other communication partner at the destination address corresponding to the destination EID designated by the control according to the purpose of the data, the signal S4 may include the destination EID designated by the control according to the purpose of the data.

On the other hand, the DTN-1 processing unit 104 may store the signal S3 in the buffer 105 in a case where the communication with the communication partner at the destination address over the network is not enabled. After that, in a case where it is detected that the communication with the other communication partner at the destination address over the network becomes enabled, a control according to the purpose of the data may be performed again on the data (which may also be called data from the node 1 (101)) included in the signal S3 stored in the buffer 105. After the control according to the purpose of the data is performed again, the signal S4 may be transmitted to the communication partner at the destination address corresponding to the destination EID. The destination EID may be a destination EID (T1031-2) indicated in the destination information T1031 or may be destination EID designated by the control according to the purpose of the data which is performed again. For example, according to the control rule group T1042-3 of the control method T1042-2 “METHOD 1 (ELAPSED TIME T)”, referring to FIG. 6, the destination EID may be changed in accordance with the length of a time period when the state that the communication is disabled continues.

Referring to FIG. 1, the DTN-2 processing unit 203 in the server apparatus 20 may receive the signal S4 from the DTN-1 processing unit 104 and may judge whether the destination EID indicated in the signal S4 is matched with the DTN address of the node 1 indicated in the DTN setting information T203. In a case where the destination EID indicated in the signal S4 is matched with the DTN address of the node 1 (which may also be called a DTN node or a DTN2 node), the DTN-2 processing unit 203 stores information (which may also be called a signal S5) relating to the signal S4 in a storage area identified with an output pointer indicated in the DTN setting information T203. The signal S5 includes the data from the node 1 (101).

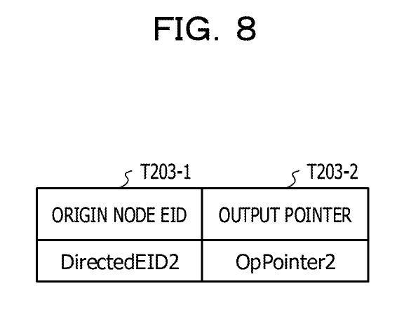

FIG. 8 illustrates an example of the DTN setting information T203. The DTN setting information T203 illustrated in FIG. 8 includes a node EID (T203-1) thereof and an output pointer T203-2. The node EID (T203-1) thereof indicates a DTN address for identifying the DTN-2 processing unit 203 in the server apparatus 20. The output pointer T203-2 indicates a position on a storage area for storing information (signal S5) regarding the signal S4 indicating the same destination EID as the node EID (T203-1) thereof. In the example in FIG. 8, an output pointer T203-2 “OpPointer 2” is set for the node EID (T203-1) “DirectedEID2”.

The proxy-2 processing unit 202 in the server apparatus 20 monitors whether the signal S5 is stored in a predetermined storage area based on the output pointer indicated in the node setting information T202. When it is detected that the signal S5 is stored in the storage area indicated in the output pointer, the information (which may also be called a signal S6) regarding the signal S5 to a node 2 address corresponding to the output pointer based on the node setting information T202. The signal S6 includes the data from the node 1 (101).

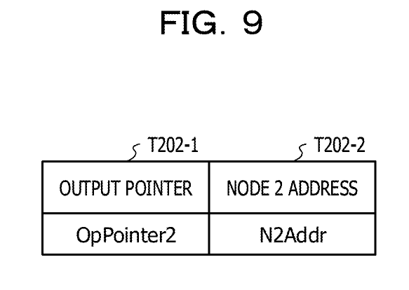

FIG. 9 illustrates examples of the node setting information T202. The node setting information T202 illustrated in FIG. 9 includes an output pointer T202-1 and a node 2 address T202-2. The output pointer T202-1 is information indicating a position on a storage area for storing the signal S5 including the data from the node 1 (101). The node 2 address T202-2 indicates an address of the node 2 (201) in the server apparatus 20 and may include an IP address and a port number, for example. In the example in FIG. 9, a node 2 address T202-2 “N2Addr” is set for the output pointer T202-1 “OpPointer 2”.

According to the signal flow between nodes illustrated in FIG. 1, data transmitted from the node 1 (101) in the terminal apparatus 10 is relayed to the node 2 (201) in the server apparatus 20 through a relay communication (which may also be called a transfer processing) based on the DTN protocol. In this case, according to the control rule based on the purpose of the data (which may also be called transfer data) transmitted from the node 1 (101), the transfer processing to be performed on the transfer data may be controlled.

Next, a flow of processing relating to execution of a control rule based on the purpose of data will be described at a DTN node which relays communication between the terminal apparatus 10 and the server apparatus 20.

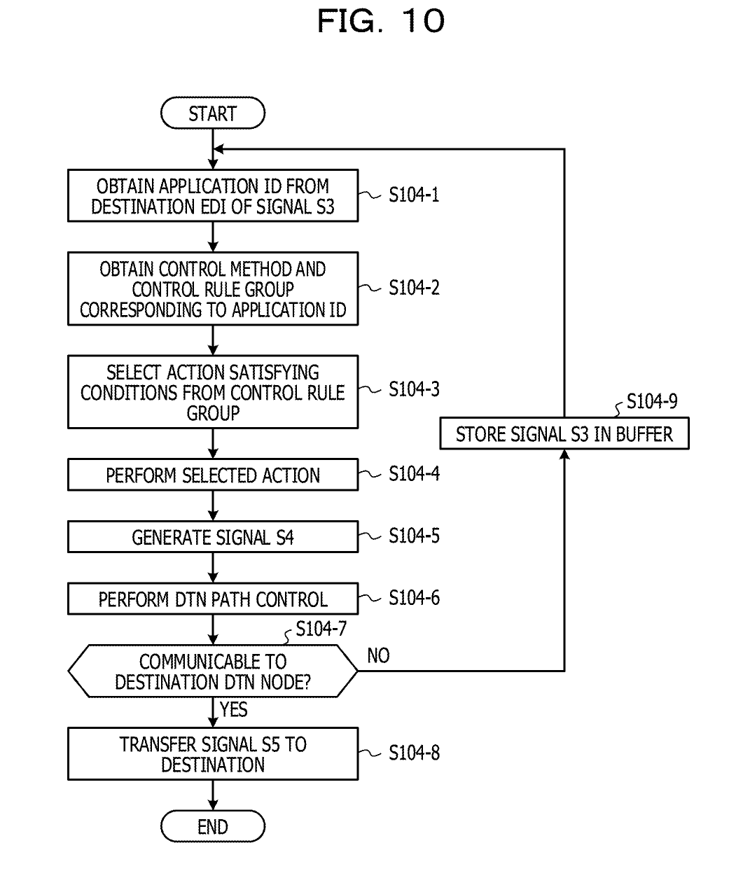

FIG. 10 illustrates an example of a flow of a transmission processing at a DTN node according to Embodiment 1. The flow of the processing illustrated in FIG. 10 may start executing in response to receipt of the signal S3 from the proxy-1 processing unit 103 by the DTN-1 processing unit 104. The subject of the execution of the transmission processing at the DTN node illustrated in FIG. 10 is the DTN-1 processing unit 104 in the following descriptions.

The DTN-1 processing unit 104 obtains an application ID from the destination EID indicated in the signal S3 (S104-1). The destination EID indicated in the signal S3 may have an information structure “dtn://<destination node name>/<application ID>”. For example, when the destination EID is represented by a character string “dtn://serverA/AppID1”, the application ID is “AppID1”. In the example above, the destination node name is “serverA”.

The DTN-1 processing unit 104 obtains the control method and the control rule group (which may also be called a control method T1042-2 and a control rule group T1042-3) corresponding to the application ID based on the application information T1041 and the control rule information T1042 (S104-2). In S104-2, the DTN-1 processing unit 104 may obtain a control ID (T1041-2) corresponding to the application ID (that is the application ID obtained from the destination EID indicated in the signal S3) based on the application information T1041. In S104-2, the DTN-1 processing unit 104 may obtain the control method T1042-2 and a control rule group T1042-3 corresponding to the control ID (T1041-2, T1042-1) based on the control rule information T1042.

The DTN-1 processing unit 104 selects an action satisfying a condition in the control rule group obtained in S104-2 (S104-3). In S104-3, the DTN-1 processing unit 104 may perform judgment on the condition indicated in the control rule group according to the control method obtained in S104-2. For example, according to the control method T1042-2 “METHOD 1 (ELAPSED TIME T)” in FIG. 6, satisfaction of one condition is judged based on an elapsed time T relating to the data from the node 1 (101). The elapsed time T relating to the data from the node 1 (101) may be an elapsed time from a time when the data from the node 1 (101) is transferred to the DTN-1 processing unit 104 or an elapsed time (which may also be called an elapsed time from data generation) from a time when the signal S1 including the data in the node 1 (101) is generated.

The DTN-1 processing unit 104 executes the action selected in S104-3 (S104-4). For example, in S104-3, in a case where it is judged that the condition T1042-3-1 “1 MIN T<10 MIN” is satisfied according to the control method T1042-2 “METHOD 1 (ELAPSED TIME T)” in FIG. 6 and where an action T1042-3-2 “TRANSFER TO DESTINATION EID3” corresponding to the condition T1042-3-1 “1 MIN T<10 MIN” is selected, executing the action T1042-3-2 “TRANSFER TO DESTINATION EID3” in S104-4 results in designation of “destination EID3” as a destination of the data included in the signal S3. For example, in S104-3, in a case where it is judged that a condition T1042-3-1 “T<1 MIN” is satisfied according to the control method T1042-2 “METHOD 1 (ELAPSED TIME T)” in FIG. 6 and where the action T1042-3-2 “TRANSFER TO DESTINATION EID2” corresponding to the condition T1042-3-1 “T<1 MIN” is selected, executing the action T1042-3-2 “TRANSFER TO DESTINATION EID2” in S104-4 results in designation of “destination EID2” as a destination of the data included in the signal S3. For example, in a case where it is judged in S104-3 that a condition T1042-3-1 “10 MIN T” is satisfied according to the control method T1042-2 “METHOD 1 (ELAPSED TIME T)” in FIG. 6 and where an action T1042-3-2 “ABANDON” corresponding to the condition T1042-3-1 “10 MIN T” is selected, executing the action T1042-3-2 “ABANDON” in S104-4 results in abandoning the data included in the signal S3 without transferring.

After the action is executed in S104-4, the DTN-1 processing unit 104 generates, from the data included in the signal S3, a signal S4 to be transmitted to a transfer destination DTN node (which may also be called a transfer destination DTN node) indicated by the destination EID (S104-5). According to the DTN protocol, the signal S4 may be called a bundle.

The DTN-1 processing unit 104 executes a DTN path control including obtaining a destination address from the destination EID of the signal S4 based on the DTN path information T1043 (S104-6). The destination address indicates an address over a network of an apparatus on which the transfer destination DTN node runs and may include an IP address and a port number.

The DTN-1 processing unit 104 judges whether communication to a destination DTN node (which may also be called a transfer destination DTN node) is enabled based on the destination address obtained by the DTN path control (S104-6) (S104-7). For example, in a case where a signal for reach check such as a Ping is transmitted to the DTN node designated with the destination address and where a response to the signal for reach check is received within a predetermined time period, the DTN-1 processing unit 104 may judge that the communication with the transfer destination DTN node is enabled.

In a case where it is judged in S104-7 that the communication with the destination DTN node is enabled (YES in S104-7), the DTN-1 processing unit 104 transfers the signal S4 to an apparatus that is the transfer destination indicated by the destination address (S104-8).

On the other hand, in a case where it is judged in S104-7 that the communication with the destination DTN node is disabled (NO in S104-7), the DTN-1 processing unit 104 stores the signal S3 in the buffer 105 (S104-9) and, after a wait for a predetermined period of time, may execute the processing in S104-1 and subsequent steps on the signal S3 stored in the buffer 105.

In the above, an example of the flow of the transmission processing at a DTN node according to Embodiment 1 has been described.

According to an aspect of Embodiment 1 disclosed above, a control rule based on the purpose of data from the node 1 (101) is executed in the DTN-1 processing unit 104. Therefore, at a time after the data from the node 1 (101) is transmitted, a proper control based on the purpose of the data may be executed on the data. These effects may improve communication efficiency of relay communication based on the DTN protocol and thus may inhibit waste of calculation costs in a transfer destination node (such as a node 2 (201)), which is advantageous for more efficient use of hardware resources.

### Embodiment 2

According to Embodiment 2, a terminal apparatus 10 according to the present disclosure has a configuration, which will be described in detail below.

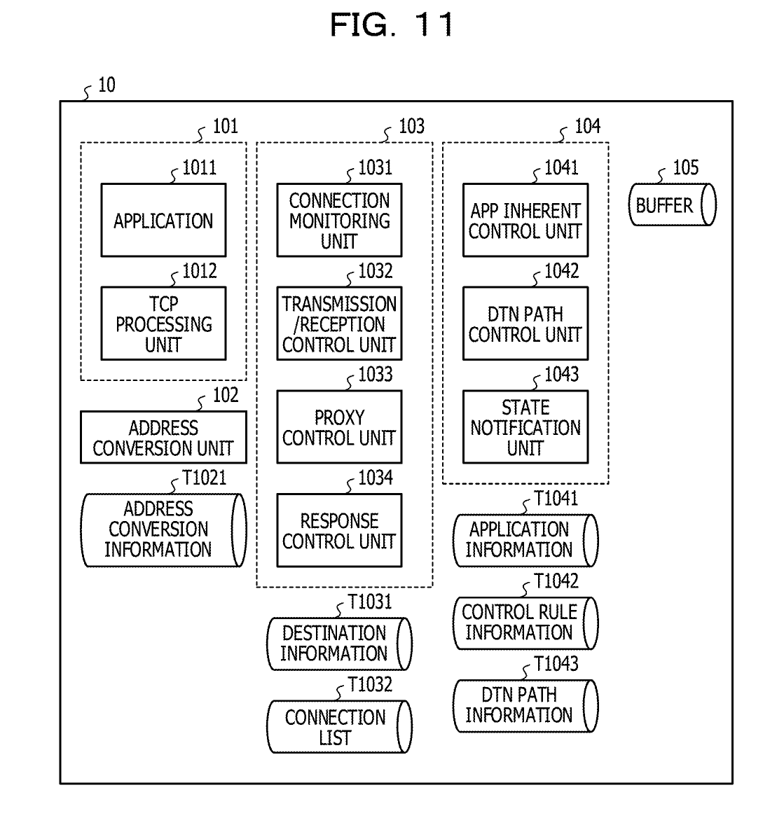

FIG. 11 illustrates an example of the configuration of the terminal apparatus 10 according to Embodiment 2. The terminal apparatus 10 illustrated in FIG. 11 includes a node 1 (101) (which may also be called a first node), an address conversion unit 102 (which may also be called a conversion-1 processing unit 102 or a first conversion processing unit), a proxy-1 processing unit 103 (which may also be called a first proxy processing unit), a DTN-1 processing unit 104 (which may also be called a first DTN processing unit), a buffer 105, an address conversion information T1021, a destination information T1031, a connection list T1032, application information T1041, a control rule information T1042, and a DTN path information T1043.

The node 1 (101) illustrated in FIG. 11 includes an application 1011 and a TCP processing unit 1012. The application 1011 is an example of an application (which may also be called a client application or a client) running on the terminal apparatus 10 and which is configured to communicate with the node 2 (201) in the server apparatus 20 through the TCP processing unit 1012 to provide a predetermined function in cooperation with the node 2 (201).

The TCP processing unit 1012 is configured to communicate based on a TCP/IP (Transmission Control Protocol/Internet Protocol) protocol stack and, for example, may be implemented by a TCP/IP communication function provided by a driver for an OS (Operating System).

The address conversion unit 102 is configured to convert a destination address of packet data (which may also be called a packet) transmitted from the application 1011 through the TCP processing unit 1012 to an address of the proxy-1 processing unit 103 based on the address conversion information T1021. For example, the address conversion unit 102 converts a destination address (destination IP address and port number) of a packet to be transmitted to the node 2 (201) in the server apparatus 20 as its destination to an address (which may also be called a proxy address, a proxy IP address and a port number) of a TCP socket (which may also be called a proxy socket or a socket) set in a transmission/reception control unit 1032, which will be described below, in the proxy-1 processing unit 103. Thus, the proxy-1 processing unit 103 may receive (obtain) the packet data to be transmitted to the node 2 (201) that is the communication destination from the application 1011. In a case where Windows (registered trademark) is used as the OS, the address conversion unit 102 may be implemented by a Windows Filtering Platform (WFP). In a case where Linux (registered trademark) is used as the OS, it may be implemented by “iptables”.

The proxy-1 processing unit 103 illustrated in FIG. 11 includes a connection monitoring unit 1031, the transmission/reception control unit 1032, a proxy control unit 1033, and a response control unit 1034.

The connection monitoring unit 1031 is configured to monitor a state of connection with the node 2 (201) that is a communication destination of the application 1011 and to control operations to be performed by the address conversion unit 102 based on the state of connection. For example, the connection monitoring unit 1031 may check a state of connection with the communication destination of the application 1011 for a predetermined period of time, and, when a response packet is not received from the communication destination, may judge that the connection is disconnected. When the connection monitoring unit 1031 judges that the connection with the communication destination is disconnected, the connection monitoring unit 1031 changes the communication method for the communication between the node 1 (101) and the node 2 (201) from a communication based on TCP/IP (which may also be called a first communication method) to a communication based on a DTN bundle protocol (which may also be called a second communication method). For example, the connection monitoring unit 1031 may set whether the destination node address T1021-1 is valid as a conversion subject or not in the address conversion information T1021 to instruct the communication method to the address conversion unit 102. In this case, a valid conversion subject means a communication based on the second communication method, and invalid conversion subject means a communication based on the first communication method.

The transmission/reception control unit 1032 is configured to generate the socket for receiving data from the node 1 (101) based on a proxy address T1031-1 of the destination information T1031. The proxy address T1031-1 of the destination information T1031 corresponds to the proxy address T1021-2 of the address conversion information T1021.

The transmission/reception control unit 1032 divides the packet (which may also be called data) received from the node 1 (101) via the socket into data having a size designated under a policy (algorithm or processing policy) set by a user or an operator to output to the proxy control unit 1033. The size of the division may be equal to a data size received from an open to a close of the socket, the size of the received packet or a predetermined value, for example.

The proxy control unit 1033 is configured to accommodate the data of the packet received by the transmission/reception control unit 1032 in a payload of the proxy message to output to the DTN-1 processing unit 104 via the bundle API. Thus, the transmission of the bundle is requested from the proxy control unit 1033 to the DTN-1 processing unit 104.

The proxy control unit 1033 manages proxy messages according to connection numbers based on their destinations. The proxy control unit 1033 may register a new connection number with the connection list T1032 every time the transmission/reception control unit 1032 opens the socket.

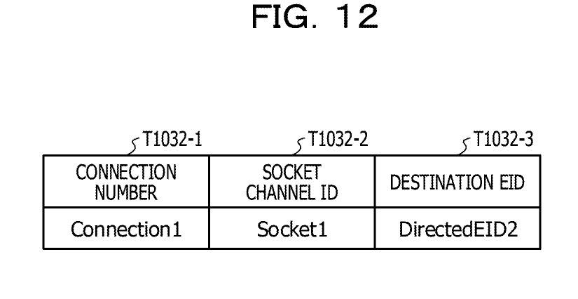

FIG. 12 illustrates an example of the connection list T1032. The connection list T1032 illustrated in FIG. 12 includes a connection number T1032-1, a socket channel ID (T1032-2), and a destination EID (T1032-3). The socket channel ID (T1032-2) indicates an identifier of the socket of the transmission/reception control unit 1032 and is associated with the connection number T1032-1 and the destination EID (T1032-3). Thus, in a case where a signal is received from the node 2 (201) in response to transmission of a signal to node 2 (201) in the server apparatus 20, the proxy control unit 1033 may obtain, from the connection list T1032, a socket channel ID (T1032-2) associated with the connection number T1032-1 included in the received signal from the node 2 (201). By obtaining the socket channel ID (T1032-2) corresponding to the connection number T1032-1 included in the received signal from the node 2 (201), the proxy control unit 1033 may transfer the signal from the node 2 (201) to the node 1 (101) via the socket corresponding to the socket channel ID (T1032-2).

The proxy control unit 1033 provides a connection number according to the socket channel ID of the original destination socket of the packet to the proxy message to output to the DTN-1 processing unit 104. In this case, the proxy control unit 1033 obtains a destination EID corresponding to the socket via which the data from the node 1 (101) has been received based on the destination information T1031 and provides the destination EID to the proxy message. In other words, for example, the proxy control unit 1033 requests the DTN-1 processing unit 104 to transmit the bundle to the destination EID. The EID of the DTN-2 processing unit 203 (which may also be called a transfer destination DTN node) corresponding to the node 2 (201) is registered with the destination EID (T1032-3) of the connection list T1032. The proxy control unit 1033 obtains the destination EID of the transfer destination DTN node based on the destination EID (T1031-2) of the destination information T1031.

The proxy control unit 1033 may be configured to receive the proxy message from the DTN-1 processing unit 104. In a case where the connection number of the received proxy message is not registered with the connection list T1032, the proxy control unit 1033 instructs the transmission/reception control unit 1032 to open a new socket to start communication via the socket. In this case, the proxy control unit 1033 may obtain the proxy address T1031-1 corresponding to the destination EID indicated in the proxy message received from the DTN-1 processing unit 104 based on the destination information T1031 and may instruct to open a new socket by using the proxy address T1031-1.

In a case where the received proxy message does not accommodate data, the proxy control unit 1033 may obtain the socket channel ID corresponding to the connection number indicated in a protocol message based on the connection list T1032 and may instruct the transmission/reception control unit 1032 to delete the socket corresponding to the socket channel ID.

In a case where a communication from the application 1011 requests a response, the response control unit 1034 generates the response to output to the application 1011. Thus, in a case where a disconnection results in disruption of a communication with a communication destination, the application 1011 may continue operating without knowing the disruption of the communication. In other words, for example, the application 1011 may not retry the communication after re-connection of the connection. In other words, for example, the response control unit 1034 hides a state in which the connection with the communication partner has been disconnected from the application 1011. Thus, the application 1011 may concentrate on the original processing without being aware of whether the communication is being disconnected or not.

For example, in a case where the proxy control unit 1033 instructs the DTN-1 processing unit 104 to relay a communication of the application 1011, the response control unit 1034 may output a response to the communication to the application 1011. In a case where a file is divided and is transferred from the application 1011 to the node 2 (201), the response control unit 1034 may output the response to the application 1011 by proxy of the node 2 (201) to prompt the application 1011 to transmit the next file data.

The DTN-1 processing unit 104 illustrated in FIG. 11 includes an app inherent control unit 1041 a DTN path control unit 1042, a state notification unit 1043 and is configured to change a communication from the node 1 (101) to the node 2 (201) from a communication based on TCP/IP (which may also be called a first communication method to a communication (which may also be called a second communication method) based on a DTN bundle protocol according to the state of connection with the communication destination (node 2 (201)).

The app inherent control unit 1041 (which may also be called a transfer control unit) is configured to obtain an application ID indicating a purpose of data from the node 1 (101) based on the destination EID indicated in a request from the proxy control unit 1033 and executes a control rule corresponding to the application ID according to application information T1041 and control rule information T1042. Thus, on the data transmitted from application 1011, a control for the purpose of the data may be executed in the DTN-1 processing unit 104.

The DTN path control unit 1042 is configured to transfer bundle data generated based on data from the application 1011 to a transfer destination DTN node according to DTN path information T1043. The DTN path control unit 1042 may perform communication based on a bundle protocol according to RFC5050 provisions. In this case, the DTN path control unit 1042 accommodates the data from the application 1011 in a payload part of a data message called a bundle for transmission. Specifications of fields within the bundle are provided in RFC5050.

The DTN path control unit 1042, for transmitting the bundle, obtains a destination IP address and a TCP port number (which may also be called a port number) based on TCP/IP corresponding to the EID (Endpoint ID) indicating the destination based on the bundle protocol with reference to the DTN path information T1043. When the connection with the transfer destination DTN node is disconnected, the DTN path control unit 1042 may store the bundle in a buffer 105 (which may also be called a bundle buffer) and, when the connection is re-connected, read out and transmit the bundle from the buffer 105.

The state notification unit 1043 is configured to notify communication information regarding a state and a result of a communication to a user by presenting a pop-up display or a log on a screen, for example. For example, the state notification unit 1043 may output communication information to a display unit (liquid crystal display, for example) in the terminal apparatus 10 or may write communication information in a log file. The notification information may include a result of execution of a control rule according to the purpose of the data from the node 1 (101) by the app inherent control unit 1041.

In the above, the configuration of the terminal apparatus 10 according to Embodiment 2 has been described. The server apparatus 20 may include the same configuration as that of the terminal apparatus 10 according to Embodiment 2 or may include a configuration excluding a part of the configuration of the terminal apparatus 10. For example, the server apparatus 20 may exclude a component corresponding to the app inherent control unit 1041.

### Variation Example 1

Having described that, according to the Embodiments 1 and 2, the terminal apparatus 10 has the node 1 (101), the conversion-1 processing unit 102, the proxy-1 processing unit 103, and the DTN-1 processing unit 104, the present disclosure is not limited thereto. For example, some components of the node 1 (101), the conversion-1 processing unit 102, the proxy-1 processing unit 103, and the DTN-1 processing unit 104 may be implemented in an apparatus different from the terminal apparatus 10.

### Variation Example 2

Having described that, according to Embodiments 1 and 2, the server apparatus 20 includes the node 2 (201), the proxy-2 processing unit 202, and the DTN-2 processing unit 203, the present disclosure is not limited thereto. For example, some components of the node 2 (201), the proxy-2 processing unit 202, and the DTN-2 processing unit 203 may be implemented in an apparatus different from the server apparatus 20.

Hardware Configuration Example

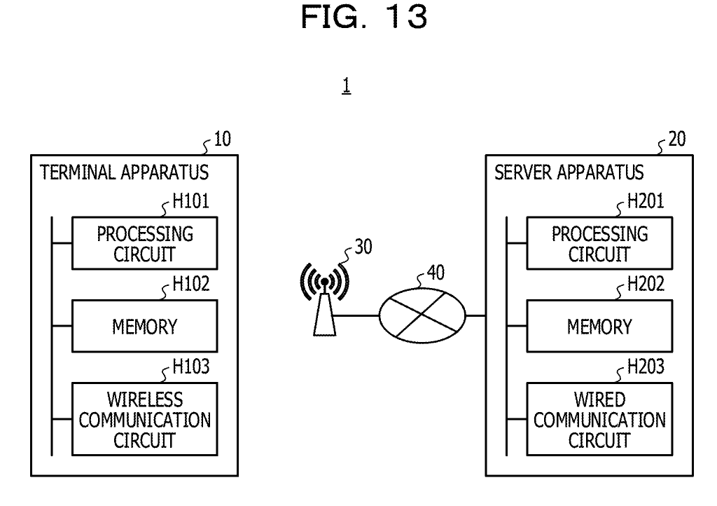

Finally, hardware configurations of the apparatuses according to the aforementioned embodiments disclosed herein will be described briefly. FIG. 13 illustrates examples of hardware configurations of the terminal apparatus 10 and the server apparatus 20 in the system 1. FIG. 13 illustrates an access point 30 enabling a wireless communication with the terminal apparatus 10 and a wired or wireless network 40. The terminal apparatus 10 and the server apparatus 20 illustrated in FIG. 13 may be configured to be communicable via the access point 30 and over the network 40, for example.

The terminal apparatus 10 illustrated in FIG. 13 includes a processing circuit H101 (which may also be called a first processing circuit), a memory H102 (which may also be called a first memory), and a wireless communication circuit H103 (which may also be called a first communication circuit). Some components such as an antenna of the terminal apparatus 10 are not illustrated in FIG. 13. The terminal apparatus 10 may further have various components including a display device such as a liquid crystal display, an input device such as a touch panel, and a battery such as a lithium-ion rechargeable battery.

The processing circuit H101 (which may also be called a processor circuit or a computing circuit) may be a computing apparatus (which may also be called a computer) which implements processing in the terminal apparatus 10 according to Embodiment 1 or 2 by reading out and executing a program (which may also be called a relay communication program) stored in the memory H102. In other words, for example, the processing circuit H101 according to an aspect is an execution subject of processing units (such as the node 1 (101), the address conversion unit 102, the proxy-1 processing unit 103, and the DTN-1 processing unit 104) of the terminal apparatus 10 according to Embodiment 1 or 2. Further In other words, for example, the processing circuit H101 may execute a predetermined program (such as a relay communication program) for conversion to hardware circuits implementing functions of the node 1 (101), the address conversion unit 102, the proxy-1 processing unit 103, and the DTN-1 processing unit 104. The processing circuit H101 may be, for example, a central processing unit (CPU), a micro processing unit (MPU), a digital signal processor (DSP) or a field programmable gate array (FPGA). The processing circuit H101 may be a multi-core processor including two or more cores.

The memory H102 is a circuit configured to store and hold data and a program (which may also be called a relay communication program) relating to processes to be executed by the processing circuit H101. The memory H102 may be configured by including both or at least one of a nonvolatile storage device and a volatile storage device. For example, it may include a random access memory (RAM), a read only memory (ROM), a solid state drive (SSD), and a hard disk drive (HDD). Referring to FIG. 13, the memory H102 is a general germ of storage devices such as a main storage device and an auxiliary storage device. A relay communication program according to the present disclosure may be pre-stored in the memory H102 or may be downloaded from a program distribution device (not illustrated) connected to the memory H102 over a network and be stored therein.

The wireless communication circuit H103 may be wirelessly connected to the access point 30 connected to the network 40 to be communicable with the server apparatus 20 over the network 40. For example, wireless communication circuit H103 may be a communication module based on a wireless LAN (Local Area Network) standard such as Wi-Fi or may be a communication module based on a 3GPP standard such as Long Term Evolution (LTE).

The server apparatus 20 illustrated in FIG. 13 includes a processing circuit H201 (which may also be called a second processing circuit), a memory H202 (which may also be called a second memory), and a wired communication circuit H203 (which may also be called a second communication circuit). Some components such as an antenna of the server apparatus 20 are not illustrated in FIG. 13.

The processing circuit H201 (which may also be called a processor circuit or a computing circuit) may be a computing apparatus (which may also be called a computer) which implements processing in the server apparatus 20 according to Embodiment 1 or 2 by reading out and executing a program (which may also be called a relay communication program) stored in the memory H202. In other words, for example, the processing circuit H201 according to an aspect is an execution subject of processing units (such as the node 2 (201), the proxy-2 processing unit 202, and the DTN-2 processing unit 203) of the server apparatus 20 according to Embodiment 1 or 2. Further In other words, for example, the processing circuit H201 may execute a predetermined program (such as a relay communication program) for conversion to hardware circuits implementing functions of the node 2 (201), the proxy-2 processing unit 202, and the DTN-2 processing unit 203. The processing circuit H201 may be, for example, a central processing unit (CPU), a micro processing unit (MPU), a digital signal processor (DSP) or a field programmable gate array (FPGA). The processing circuit H201 may be a multi-core processor including two or more cores.

The memory H202 is a circuit configured to store and hold data and a program (which may also be called a relay communication program) relating to processes to be executed by the processing circuit H201. The memory H202 may be configured by including both or at least one of a nonvolatile storage device and a volatile storage device. For example, it may include a random access memory (RAM), a read only memory (ROM), a solid state drive (SSD), and a hard disk drive (HDD). Referring to FIG. 13, the memory H202 is a general germ of storage devices such as a main storage device and an auxiliary storage device. A relay communication program according to the present disclosure may be pre-stored in the memory H202 or may be downloaded from a program distribution device (not illustrated) connected to the memory H202 over a network and be stored therein.

The wired communication circuit H203 is a communication module configured to be communicable with the terminal apparatus 10 connected to the network 40 via the access point 30.

From the detail descriptions above, features and advantages of the aforementioned embodiments become apparent. It is intended that claims would cover the features and advantages of the aforementioned embodiments without departing from the spirit and right scope of the present disclosure. Those who have common knowledge in the art could easily reach all improvements and changes. Therefore, it is not intended that the scope of the inventive embodiments is limited to the aforementioned one and may rely on appropriate improvements and equivalents included in the scope disclosed in the embodiments. For example, the processes disclosed herein may not be performed in time series and in order disclosed as an example of the flow of processing, and the order of the processes may be changed or a plurality of processes may be executed in parallel without departing from the spirit and scope of the claimed disclosure. Matters that may occur in the system 1 that become apparent from the detail descriptions above may be found in review of the system 1 according to one aspect, and it is noted that other matters could be found in review of other aspects thereof. In other words, for example, features and advantages of the present disclosure are not limited to the purposes that are effective for the matters specified in the detail descriptions above.

Finally, the configurations of embodiments of the present disclosure illustrate examples for embodying the technical ideas of the present disclosure, and it is not intended that the present disclosure is limited by the configurations of the embodiments. The present disclosure is equally applicable to other embodiments included in the claims. For example, it is to be noted that the terms in the descriptions of the present disclosure may be named differently in accordance with changes in future technical trends. It is to be noted that one or more other names enumerated for a term according to the present disclosure are synonymous with each other.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A relay communication apparatus comprising:
a buffer configured to store data to be relayed from a first apparatus to a second apparatus in a case where the data is to be relayed from the first apparatus to the second apparatus and when a communication link with the second apparatus is not established; and
a transfer control circuitry configured to control transfer processing on the data based on at least one control rule according to a purpose of the data before the data is transferred to the second apparatus and according to a disruption tolerant protocol when a communication link with the second apparatus is established.

2. The relay communication apparatus according to claim 1,
wherein the control rule includes a condition and an action to be executed in a case where the condition is satisfied, and
wherein the transfer control circuitry is configured to
obtain application identification information indicating the purpose of the data from the first apparatus;
obtain a control method for the data and the at least one control rule based on the application identification information;
measure a value to be applied to the control rule based on the control method;
select the control rule with the measurement result satisfying the condition from the at least one control rule; and
execute the action included in the selected control rule.

3. The relay communication apparatus according to claim 2,
wherein the control method causes the transfer control circuitry to measure a value inherent to the data; and
wherein the action is executed for causing the transfer control circuitry to control a transfer destination of the data based on the measurement result.

4. The relay communication apparatus according to claim 3,
wherein the value inherent to the data is an elapsed time from a time when the data is generated; and
wherein, in a case where the measurement result is equal to or higher than a first threshold value, the action causes the transfer control circuitry to change the transfer destination of the data.

5. The relay communication apparatus according to claim 4,
wherein the action causes the transfer control circuitry to abandon the data in a case where the measurement result is equal to or higher than a second threshold value higher than the first threshold value.

6. A relay communication method comprising:
obtaining data to be relayed from a first apparatus to a second apparatus in a case where the data is to be relayed from the first apparatus to the second apparatus and when a communication link with the second apparatus is not established; and
executing a transfer control process that controls transfer processing on the data based on at least one control rule according to a purpose of the data before the data is transferred to the second apparatus and according to a disruption tolerant protocol when a communication link with the second apparatus is established.

7. The relay communication method according to claim 6,
wherein the control rule includes a condition and an action to be executed in a case where the condition is satisfied, and
wherein the transfer control process is configured to
obtain application identification information indicating the purpose of the data from the first apparatus;
obtain a control method for the data and the at least one control rule based on the application identification information;
measure a value to be applied to the control rule based on the control method;
select the control rule with the measurement result satisfying the condition from the at least one control rule; and
execute the action included in the selected control rule.

8. The relay communication method according to claim 7,
wherein the control method causes the transfer control process to measure a value inherent to the data; and
wherein the action is executed for causing the transfer control process to control a transfer destination of the data based on the measurement result.

9. The relay communication method according to claim 8,
wherein the value inherent to the data is an elapsed time from a time when the data is generated; and
wherein, in a case where the measurement result is equal to or higher than a first threshold value, the action causes the transfer control process to change the transfer destination of the data.

10. The relay communication method according to claim 9,
wherein the action causes the transfer control process to abandon the data in a case where the measurement result is equal to or higher than a second threshold value higher than the first threshold value.

11. A non-transitory computer-readable storage medium for storing a program for relay communication, the program causing a processor to perform processing, the processing comprising:
obtaining data to be relayed from a first apparatus to a second apparatus in a case where the data is to be relayed from the first apparatus to the second apparatus and when a communication link with the second apparatus is not established; and
executing a transfer control process that controls transfer processing on the data based on at least one control rule according to a purpose of the data before the data is transferred to the second apparatus and according to a disruption tolerant protocol when a communication link with the second apparatus is established.

12. The non-transitory computer-readable storage medium according to claim 11,
wherein the control rule includes a condition and an action to be executed in a case where the condition is satisfied, and
wherein the transfer control process is configured to
obtain application identification information indicating the purpose of the data from the first apparatus;
obtain a control method for the data and the at least one control rule based on the application identification information;
measure a value to be applied to the control rule based on the control method;
select the control rule with the measurement result satisfying the condition from the at least one control rule; and
execute the action included in the selected control rule.

13. The non-transitory computer-readable storage medium according to claim 12,
wherein the control method causes the transfer control process to measure a value inherent to the data; and
wherein the action is executed for causing the transfer control process to control a transfer destination of the data based on the measurement result.

14. The non-transitory computer-readable storage medium according to claim 13,
wherein the value inherent to the data is an elapsed time from a time when the data is generated; and
wherein, in a case where the measurement result is equal to or higher than a first threshold value, the action causes the transfer control process to change the transfer destination of the data.

15. The non-transitory computer-readable storage medium according to claim 14,
wherein the action causes the transfer control process to abandon the data in a case where the measurement result is equal to or higher than a second threshold value higher than the first threshold value.
